(19) United States
(12) Patent Application Publication
(10) Pub. No.: US 2021/0188015 A1
(43) Pub. Date: Jun. 24, 2021

(54) CROWN HAVING COLORED WEAR IDENTIFICATION LAYER AND TIRE

(71) Applicant: Hebei Wanda Tyre Co., Ltd, Hebei (CN)

(72) Inventors: Peng GENG, Tianjin (CN); Zhili LAI, Tianjin (CN); Mingzhen YU, Tianjin (CN)

(73) Assignee: Hebei Wanda Tyre Co., Ltd, Hebei (CN)

(21) Appl. No.: 16/719,957

(22) Filed: Dec. 18, 2019

(51) Int. Cl. B60C 11/24; B60C 11/00

(52) U.S. Cl. CPC B60C 11/24; B60C 11/005

(57) ABSTRACT

A crown having a colored wear identification layer and a tire are provided. The crown includes an upper tread layer, a colored wear identification layer, and a lower tread layer sequentially bonded. The surface of the upper tread layer is provided with grooves and bosses positioned between the grooves, the colored wear identification layer has an uniform thickness and continuously extends with an uniform depth below the surfaces and inside the side surfaces of the bosses and the grooves. The tire includes the crown. A manufacturing method of the tire is also provided. According to the technical scheme, when the pattern, namely the boss or the groove part, of the tire wears or abrades, once the tire abrades to a certain degree, the arranged colored wear identification layer can be exposed, so that the user is warned that the tire should be replaced or maintained.

### BACKGROUND

### Technical Field

The disclosure is related to the field of wheel tire manufacturing, and particularly relates to a crown having a colored wear identification layer and a tire.

### Description of Related Art

In our daily vehicle, the tire is one of the most seriously abraded parts. The abrasion degree of the tire can be used for judging whether replacement is needed or not and where the vehicle has problems, and if the replacement is not carried out in time, the problems bring damages to other parts, and vehicle deviation, shake and even abnormal sound can be caused.

Tire abrasion is mainly classified as normal abrasion or abnormal abrasion. The normal abrasion refers to uniform abrasion of the tire, which means that no single point or excessive abrasion on one side of the tire occurs. Only when the tire abrades to prompt replacement, dynamic balance is performed with no more adjustment.

However, there are many abnormal abrasion conditions, and it is difficult to effectively identify and process for a general vehicle user. For example, the abnormal abrasion includes: 1) tire outside wear: when the camber angle of the front wheel is too large, the outside of the tire abrades; 2) tire middle abrasion: when the camber angle is too small or does not exist, the inside of the tire abrades; 3) tire middle abrasion: the main reason is too much inflating volume which not only affects the vibration damping performance of the tire, but also deforms the tire to reduce the contact surface with the ground, and normal abrasion can only be borne by the central part of the tire and form abrasion; 4) tire irregular abrasion: problems of camber angle and inward camber or deformation of related parts of the chassis lead to irregular tire gnawing, and the like.

To enable a common vehicle occupant to effectively identify tire abrasion, abrasion identification techniques have been developed in the art. For example, Chinese Patent Publication No. CN200948738Y discloses an aircraft tire with a wear identification rubber sheet. The tire includes a tread rubber, a reinforcing layer, a carcass ply, an airtight layer and a tire bead coating rubber. A layer of wear identification rubber sheet is arranged on the lower part of the tire tread rubber or the upper part of the carcass ply, and the wear identification rubber sheet is tightly bonded with the tread rubber and the carcass ply into a whole. However, since the wear identification rubber sheet is disposed completely below the reinforcing layer, it is only possible to expose the wear identification rubber sheet after the raised pattern of the tread or even the reinforcing layer is completely abraded, at which time the degree of abrasion of the tire can be clearly visually detected, resulting in the wear identification rubber sheet substantially losing its intended wear identification function.

Therefore, there remains a need in the art for a method or means with convenient manufacture that can assist a vehicle user in conveniently and quickly identifying tire abrasion.

### SUMMARY

Aiming at the defects of the prior art, the disclosure has an object to provide a crown having a colored wear identification layer and a tire including the crown, wherein the wear identification layer can assist a vehicle user to conveniently and quickly identify the abrasion condition of the tire, so that the user can be timely warned to replace or maintain the tire. The above object is achieved by the following scheme.

In an aspect, the present disclosure provides a crown having a colored wear identification layer, the crown including an upper tread layer, a colored wear identification layer and a lower tread layer which are sequentially bonded. The surface of the upper tread layer is provided with grooves and bosses positioned between the grooves, the colored wear identification layer has an uniform thickness and continuously extends with an uniform depth below the surfaces and inside the side surfaces of the bosses and the grooves. In one embodiment, the groove has a depth and the uniform depth is equal to 0.2 to 0.4 times of the depth. In another embodiment, the uniform depth is equal to 0.2, 0.3 or 0.4 times of the depth.

According to the technical scheme, the colored wear identification layer is uniformly arranged below the surface or inside the side surface of the groove and the boss of the upper tread layer. When the pattern, namely the boss (including the corner part) or the groove part, of the tire wears or abrades, once the tire abrades to a certain degree, the arranged colored wear identification layer can be exposed, so that the user is warned that the tire should be replaced or maintained. Since the colored wear identification layer is uniformly distributed at the same depth from the surface or the side surface, even if the corner part of the boss or the groove part and the side surface part are seriously worn, the colored wear identification layer can be exposed, so that a user can conveniently, timely and comprehensively monitor the wear condition of the tire and timely process the tire. In addition, in the technical scheme, the colored wear identification layer is a continuous thin layer with uniform thickness, so that in the use process, even if severe abrasion occurs, linear color stripes (a colored wear identification layer in the middle (line shaped), and a black rubber tread layer in the upper and lower layer) can be displayed at the abrasion position. Therefore, a user can quickly identify the severity of the abrasion. In addition, due to the fact that the thickness of the colored wear layer is thin, the colored wear layer has little influence on the overall performance of the crown, and layering or even stripping caused by the fact that the colored wear identification layer is different in performance from the upper tread layer and the lower tread layer cannot occur.

Further, preferably, the colored wear identification layer has a thickness equal to 0.05 to 0.1 times of the depth. The thickness of the lower tread layer is equal to 0.5 to 1 times of the depth.

By reasonably setting the thickness of the colored wear identification layer and the thickness of the lower tread layer, the user can be reasonably warned about the wear degree, so that the user is prevented from being warned prematurely to replace the tire to cause unnecessary loss, or the user is warned late to cause excessive tire abrasion, which will bring serious potential safety hazards to the user.

Further, preferably, the colored wear identification layer is a single color layer or a multi-color layer. Further, preferably, the color of the single color layer is a bright color including, but not limited to, red, yellow, orange, green, blue, or purple, or a bright color formed by a mixture of these colors. The multi-color layer may be a multi-color layer formed by mixing two or more bright color raw materials, for example, the bright color raw materials are red, yellow, orange, green, blue or purple raw materials.

The bright color is arranged, so that a user can easily find the exposed colored wear identification layer under the condition that the crown wears, and the function of warning the user as early as possible is achieved.

In a second aspect, the present disclosure provides a tire having a crown according to the preceding first aspect.

By utilizing the tire prepared with the colored wear identification layer, a user can be timely warned to replace or maintain the tire under the condition of wear, so that the safety use performance of the tire is improved.

In a third aspect, the present disclosure provides a method of manufacturing a tire according to the preceding second aspect. Preferably, when extruding the lower tread layer, the thickness of the portion below the boss is 0.2 to 0.4 times of the depth higher than that of the remaining portion.

According to the technical scheme, due to the fact that the lower tread layer below the boss is thickened, the colored wear identification layer can become flat and straight without downward bending in the vulcanization shaping process, the manufacturing of the high-quality colored wear identification layer is facilitated, and the situation that severe wear cannot be found in time due to the occurrence of bending is avoided.

Further, preferably, the process includes the steps of: (1) preparing a wear-resistant tread rubber stock and a colored rubber stock, wherein the colored rubber stock is formed by mixing the wear-resistant tread rubber stock and colored masterbatch particles; (2) respectively mixing and banburying the wear-resistant tread rubber stock and the colored rubber stock with the banburying temperature of 170-190° C. and the stirring time of 20-50 min, so as to obtain a banburyed wear-resistant tread rubber stock and colored rubber stock; (3) feeding the banburyed wear-resistant tread rubber stock into an extruder, and extruding it by using a mold to obtain a wear-resistant tread rubber strip I used as an upper tread layer and a wear-resistant tread rubber strip II used as a lower tread layer respectively, wherein when the wear-resistant tread rubber strip is extruded, a trapezoidal recess with the depth of 3-5 mm is arranged in the middle of a lower extrusion roller, so that a trapezoidal protrusion is formed on one side of the formed wear-resistant tread rubber strip II; and tabletting the colored rubber stock by using a laminating machine to obtain a colored rubber strip used as a colored wear identification layer; in a preferred embodiment, when the wear-resistant tread rubber strip is extruded, a trapezoid protrusion with the height of 3-5 mm is arranged in the middle of the lower extrusion roller, so that a trapezoid recess is formed on one side of the formed wear-resistant tread rubber strip I; (4) preparing an inner lining layer, a steel wire wrapping cloth, a carcass cord fabric, a steel wire ring, a triangular sheet, a rubber pad and a sidewall layer, and laminating them in a laminating drum with the wear-resistant tread rubber strip I, the wear-resistant tread rubber strip II and the colored rubber strip obtained in the step (3) to form a semi-finished product; and (5) transferring the semi-finished product obtained in the step (4) to a forming drum, pre-vulcanizing it for 30-50 min under the pressure condition of about 70-90 Kg/cm2 to obtain a pre-vulcanized tread, grinding, brushing with rubber cement, and putting the pre-vulcanized tread in a vulcanizing machine for vulcanization shaping to obtain a finished tire.

A tire having a colored wear identification layer can be produced by the above steps. Because the compositions of the colored rubber stock and the wear-resistant tread rubber stock are substantially the same, they are substantially the same in terms of properties, avoiding layering or even stripping caused by differences in performance during long-term use. When the wear-resistant tread rubber strip II is extruded, a trapezoidal recess with the depth of 3-5 mm is arranged in the middle of the lower extrusion roller, so that a part of the thickness of the prepared wear-resistant tread rubber strip II (for example, the thickness of a lower tread layer part which is positioned below the tire pattern boss after molding) is higher than that of the remaining portion of the wear-resistant tread rubber strip II, thereby being beneficial to forming a flat and straight colored wear identification layer below the pattern boss of the upper tread layer with no downward bending or the like.

In summary, by the technical scheme, the disclosure can achieve the following good technical effects:

(1) the colored wear identification layer is uniformly arranged below the surface or inside the side surface of the groove and the boss of the upper tread layer. Therefore, when the pattern, namely the boss or the groove part, of the tire wears or abrades, once the tire abrades to a certain degree, the arranged colored wear identification layer can be exposed, so that the tire user is warned that the tire should be replaced or maintained. Since the colored wear identification layer is uniformly distributed at the same depth from the surface or the side surface, even if the corner part of the boss or the groove part is seriously worn, the colored wear identification layer can be exposed, so that a user can conveniently and comprehensively monitor the wear condition of the tire and timely process the tire;
(2) due to the fact that the lower tread layer below the boss is thickened, the colored wear identification layer can become flat and straight without downward bending in the vulcanization shaping process, the manufacturing of the high-quality colored wear identification layer is facilitated, and the situation that severe wear cannot be found in time due to the occurrence of bending is avoided;
(3) The colored wear identification layer is a continuous thin layer with uniform thickness, so that in the use process, even if severe abrasion occurs, linear color stripes (a colored wear identification layer in the middle (line shaped), and a black rubber tread layer in the upper and lower layer) can be displayed at the abrasion position. Therefore, a user can quickly identify the severity of the abrasion;
(4) due to the fact that the thickness of the colored wear layer is thin, the colored wear layer has little influence on the overall performance of the crown, and layering or even stripping caused by the fact that the colored wear identification layer is different in performance from the upper tread layer and the lower tread layer cannot occur, so as to facilitate long-term and stable use of the tire.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

Hereinafter, some preferred embodiments of the present disclosure will be described in detail with reference to the accompanying drawings. Those skilled in the art will appreciate that these drawings are for illustrative purposes only and are not intended to limit the scope of the disclosure in any way.

FIG. 1 is a schematic cross-sectional view of a crown according to one embodiment of the present disclosure.

FIG. 2 is a partial enlarged view of a portion A-A of FIG. 1.

FIG. 3 is a schematic diagram of a crown formed with a thickness-reduced upper tread layer and a thickened lower tread layer in accordance with one embodiment of the present disclosure.

Description of Reference Numerals: 1, upper tread layer; 2, colored wear identification layer; 3, lower tread layer; 4, boss; 5, groove.

### DESCRIPTION OF THE EMBODIMENTS

Some examples of the present disclosure will now be described with reference to the accompanying drawings and examples. It will be understood by those skilled in the art that these examples are provided for the purpose of illustration only that how the scheme of the disclosure can be implemented and are not intended to limit the scope of the disclosure in any way.

The disclosure aims to provide a crown having a colored wear identification layer and a tire including the crown, wherein the wear identification layer can assist a vehicle user to conveniently and quickly identify the abrasion condition of the tire, so that it can timely replace or maintain the tire.

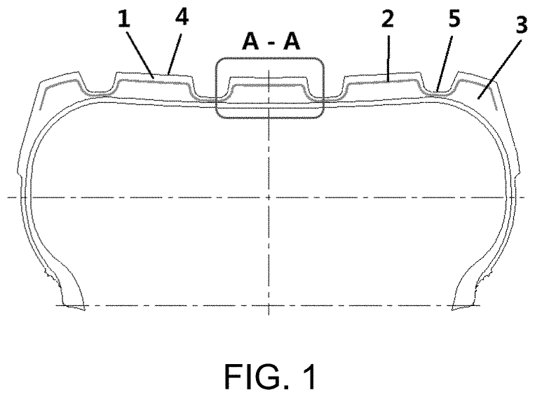

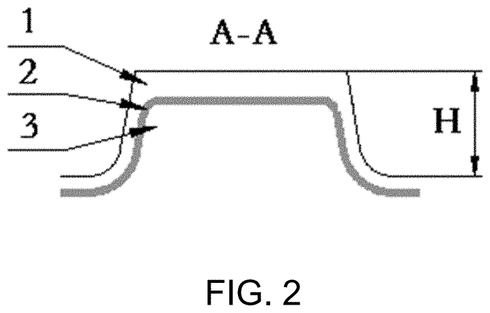

FIG. 1 is a schematic cross-sectional view of a crown according to one embodiment of the present disclosure. In FIG. 1, a crown includes an upper tread layer 1, a colored wear identification layer 2 and a lower tread layer 3 which are sequentially bonded. The surface of the upper tread layer 1 is provided with grooves and bosses positioned between the grooves, the depth of the groove is H, and the colored wear identification layer extends uniformly and continuously at a depth of 0.2H to 0.4H below the surfaces and inside the side surfaces of the bosses and the grooves. FIG. 2 is a partial enlarged view of a portion A-A of FIG. 1, wherein the distance between the upper surface of the boss and the bottom surface of the groove is H.

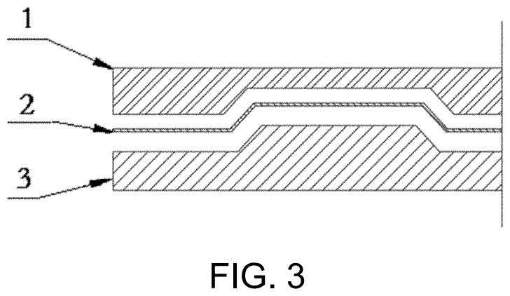

In addition, during processing, the inventors of the present application have found that thickening (thickness compensation) of the lower tread layer 3 and/or thickness-reducing of the upper tread layer (see FIG. 3) during processing of the crown (or tire) according to the present disclosure facilitates the formation of a flat and straight colored wear identification layer.

The present disclosure will now be described and illustrated in more detail with reference to examples. Those skilled in the art will appreciate that these examples are provided for illustrative purposes only, namely, to make those skilled in the art will better understand how the disclosure may be practiced, and are not intended to limit the scope of the disclosure in any way.

### Example 1

### 1. Preparing Rubber Stock

1) Wear-resistant tread rubber stock (in parts by weight): natural rubber (Shanghai Yitai International Trade Co., Ltd): 60; butadiene styrene rubber (Wuhan Nengren Pharmaceutical Chemical Co., Ltd): 30; zinc oxide (Shijiazhuang Poyun Chemical Technology Co., Ltd): 4.0; stearic acid (Shijiazhuang Poyun Chemical Technology Co., Ltd): 3.0; antioxidant D (Jinjinle Chemical Co., Ltd): 1.0; antioxidant 4010NA (Shijiazhuang Poyun Chemical Technology Co., Ltd): 1.5; antioxidant AW (Shanghai Hanhong Scientific and Technology Co., Ltd): 0.5; antioxidant H (Shenzhen Hongyuan Chemical New Material Technology Co., Ltd): 0.3; paraffin (Shanghai Jizhi Biochemical Technology Co., Ltd): 1.5; high wear resistance furnace black (Tianjin Yihuilong Chemical Technology Co., Ltd): 20; channel process (Tianjin Huaran Chemical Technology Co., Ltd): 25; coumarone resin (Shandong Yunding Chemical Co., Ltd): 5; accelerator M: 1.0 (Shijiazhuang Hongda Zinc Industry Co., Ltd.); accelerator DM (Shijiazhuang Hongda Zinc Industry Co., Ltd): 1.5;

2) Colored rubber stock (in parts by weight): the colored rubber stock is prepared by adding 2.50 parts by weight of yellow masterbatch particles (Quanzhou Haida New Material Co., Ltd.) to the above wear-resistant rubber stock.

### 2. Molding Process 1

(1) respectively mixing and banburying the wear-resistant tread rubber stock and the colored rubber stock with the banburying temperature of 170±5° C. and the stirring time of 30 min, so as to obtain a banburyed wear-resistant tread rubber stock and colored rubber stock;

(2) feeding the banburyed wear-resistant tread rubber stock into an extruder, and extruding it by using a mold to obtain a wear-resistant tread rubber strip I used as an upper tread layer and a wear-resistant tread rubber strip II used as a lower tread layer respectively, wherein when the wear-resistant tread rubber strip II is extruded, a trapezoidal recess with the depth of 4 mm is arranged in the middle of a lower extrusion roller, so that a trapezoidal protrusion is formed on one side of the formed wear-resistant tread rubber strip II; and tabletting the colored rubber stock by using a laminating machine to obtain a colored rubber strip used as a colored wear identification layer;

(3) preparing an inner lining layer, a steel wire wrapping cloth, a carcass cord fabric, a steel wire ring, a triangular sheet, a rubber pad and a sidewall layer, and laminating them in a laminating drum with the wear-resistant tread rubber strip I, the wear-resistant tread rubber strip II and the colored rubber strip obtained in the step (2) to form a semi-finished product; and

(4) transferring the semi-finished product obtained in the step (3) to a forming drum, pre-vulcanizing it for 50 min under the pressure condition of about 70 Kg/cm2 to obtain a pre-vulcanized tread, grinding, brushing with rubber cement, and putting the pre-vulcanized tread in a vulcanizing machine for vulcanization shaping to obtain a finished tire.

### 3. Molding Process 2

(1) respectively mixing and banburying the wear-resistant tread rubber stock and the colored rubber stock with the banburying temperature of 170±5° C. and the stirring time of 30 min, so as to obtain a banburyed wear-resistant tread rubber stock and colored rubber stock;

(2) feeding the banburyed wear-resistant tread rubber stock into an extruder, and extruding it by using a mold to obtain a wear-resistant tread rubber strip I used as an upper tread layer and a wear-resistant tread rubber strip II used as a lower tread layer respectively, wherein when the wear-resistant tread rubber strip II is extruded, a trapezoidal recess with the depth of 4 mm is arranged in the middle of a lower extrusion roller, so that a trapezoidal protrusion is formed on one side of the formed wear-resistant tread rubber strip II; when the wear-resistant tread rubber strip I is extruded, a trapezoid protrusion with the height of 4 mm is arranged in the middle of the lower extrusion roller, so that a trapezoid recess is formed on one side of the formed wear-resistant tread rubber strip I; and tabletting the colored rubber stock by using a laminating machine to obtain a colored rubber strip used as a colored wear identification layer;

(3) preparing an inner lining layer, a steel wire wrapping cloth, a carcass cord fabric, a steel wire ring, a triangular sheet, a rubber pad and a sidewall layer, and laminating them in a laminating drum with the wear-resistant tread rubber strip I, the wear-resistant tread rubber strip II and the colored rubber strip obtained in the step (2) to form a semi-finished product; and

(4) transferring the semi-finished product obtained in the step (3) to a forming drum, pre-vulcanizing for 50 min under the pressure condition of about 70 Kg/cm2 to obtain a pre-vulcanized tread, grinding, brushing with rubber cement, and putting the pre-vulcanized tread in a vulcanizing machine for vulcanization shaping to obtain a finished tire.

This particular example is merely illustrative of the disclosure and is not intended to limit the disclosure. Those skilled in the art can make modifications to the present example that are not creatively contributed as needed after reading this specification, but are protected by the patent law within the scope of the claims of the present disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A crown, comprising:
an upper tread layer, a colored wear identification layer, and a lower tread layer sequentially bonded,
wherein a surface of the upper tread layer is provided with a plurality of grooves and a plurality of bosses positioned between the plurality of grooves, the colored wear identification layer comprises an uniform thickness and continuously extends with an uniform depth below surfaces and inside side surfaces of the bosses and the grooves.

2. The crown according to claim 1, wherein the groove has a depth and the uniform depth is equal to 0.2 to 0.4 times of the depth.

3. The crown according to claim 2, wherein the uniform depth is equal to 0.2, 0.3 or 0.4 times of the depth.

4. The crown according to claim 2, wherein the colored wear identification layer has a thickness equal to 0.05 to 0.1 times of the depth, and the lower tread layer has a thickness equal to 0.5 to 1 times of the depth.

5. The crown according to claim 1, wherein the colored wear identification layer is a single color layer or a multi-color layer.

6. The crown according to claim 5, wherein a color of the single color layer is a bright color, and the bright color comprises red, yellow, orange, green, blue or purple, or a color formed by a mixture thereof.

7. The crown according to claim 5, wherein the multi-color layer is a multi-color layer formed by mixing two or more bright color raw materials, and the bright color raw materials comprise red, yellow, orange, green, blue or purple raw materials.

8. A tire, comprising the crown according to claim 1.
